(19) United States
(12) Patent Application Publication
(10) Pub. No.: US 2015/0072055 A1
(43) Pub. Date: Mar. 12, 2015

(54) CHOCOLATE PITA DESSERT

(71) Applicant: John Vlahos, Warren, OH (US)

(72) Inventor: John Vlahos, Warren, OH (US)

(21) Appl. No.: 14/480,922

(22) Filed: Sep. 9, 2014

Related U.S. Application Data
(60) Provisional application No. 61/875,146, filed on Sep. 9, 2013.

(51) Int. Cl. A23G 1/54; A47F 3/04; A47F 3/10; A23G 1/00

(52) U.S. Cl. CPC A23G 1/54; A23G 1/0009; A47F 3/043; A47F 3/0434; A47F 3/10; A23V 2002/00
USPC 426/289; 62/246

(57) ABSTRACT

A gyro-style pita dessert with an example of its method of preparation including a recipe and an apparatus for use in holding a chocolate cone at a desired temperature for preparing the dessert.

### CROSS-REFERENCES TO RELATED APPLICATIONS

This application claims the benefit of U.S. Provisional Patent Application Ser. No. 61/875,146 filed on Sep. 9, 2013, and incorporated herein by reference in its entirety.

### BACKGROUND

The gyro has become a popular food, in particular when sold on the street, at carnivals, fairs, amusement parks, and other public venues, but also at private restaurants and fast food establishments. However, a dessert that utilizes a gyro concept has yet to be developed, and hence would be useful.

### SUMMARY

Provided is a gyro-style pita dessert, its method of preparation, its recipe, and an apparatus for use in displaying and preparing the dessert, examples of which are described herein.

Also provided method of preparing a dessert, comprising the steps of:

providing a chocolate cone in an at least partially transparent display unit at a sales location;

maintaining a desired temperature of the chocolate cone using an air conditioning system operating in conjunction with said display unit;

providing a pita;

carving the chocolate cone to obtain chocolate shavings;

placing the chocolate shavings on the pita;

wrapping the pita with the chocolate shavings to configure the pita for sale; and

selling the pita to a customer at the sales location.

Also provided is method of preparing and selling a dessert, comprising the steps of:

providing a chocolate cone on a spit in an a display unit at a sales location, wherein said display unit comprises a door for providing access to an interior of the display unit;

maintaining a desired temperature of the chocolate cone using an air conditioning system operating in conjunction with said display unit configured to heat or cool an interior of said display unit;

heating a pita;

carving the chocolate cone to obtain chocolate shavings;

placing the chocolate shavings on the heated pita resulting in said chocolate shavings at least partially melting;

adding additional dessert toppings to the heated pita;

wrapping the pita provided with the chocolate shavings and toppings to configure the pita for sale; and

selling the pita to a customer at the sales location.

Also provided is a display unit configured for use in preparing a dessert, comprising: a base; a spit configured to hold a chocolate cone in a vertical position installed on said base, said spit being configured to be installed within said display unit; at least one transparent wall installed on said base and configured to allow viewing of the chocolate cone on said spit when installed within said device; an opening configured to provide access to a worker for carving shavings from the chocolate cone provided on the spit; and an air conditioning system configured to maintain the chocolate cone at a desired temperature.

Also provided are any of the above display units adapted of a size to be placed on a counter or table for use in a sales location directly observable by a consumer.

Further provided are any of the above display units wherein said air conditioning system is configured to cool an interior of the display unit.

Further provided are any of the above display units wherein said air conditioning system is configured to cool directly cool the chocolate cone.

Further provided are any of the above display units wherein said spit is further configured to rotate the chocolate cone within said display unit.

Further provided are any of the above display units further comprising a door adapted for use with said opening.

Further provided are any of the above display units wherein said door is at least partially transparent.

Further provided are any of these methods or display units, wherein the air conditioning system is configured to cool the interior of the display unit to cool the chocolate cone.

Further provided are any of these methods or display units, wherein the air conditioning system is also configured to heat the interior of the display to heat the chocolate cone.

Further provided are any of these methods or display units, further comprising step of providing a fruit and whipped topping on the pita prior to wrapping the pita.

Further provided are any of these methods or display units, wherein the pita is heated prior to placing the chocolate shavings on the pita.

Further provided are any of these methods or display units, wherein the pita is heated prior to placing the chocolate shavings on the pita.

Further provided are any of these methods or display units, wherein the air conditioning system maintains the chocolate cone at a desired temperature of between about 65 and 70 degrees F.

Further provided are any of these methods or display units, wherein said chocolate cone is comprised of white chocolate and milk chocolate portions.

Further provided are any of these methods or display units, wherein said air conditioning system is adapted to cool the interior of the display unit.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a drawing showing one example of a pita dessert assembled as described herein;

FIG. 2 is a drawing showing a chocolate “cone” installed on a spit used for preparing the example pita dessert of FIG. 1;

FIG. 3 is a schematic diagram of a display device for holding a chocolate cone such as shown in FIG. 2 for preparing an example dessert such as shown in FIG. 1; and

FIG. 4 is a schematic showing an example arrangement of the display device of FIG. 3.

### DETAILED DESCRIPTION OF THE EXAMPLE EMBODIMENTS

The Original Chocolate Gyro (the “CHYRO™”) is a unique chocolate dessert based on the gyro sandwich, altering the traditional gyro concept to create a dessert that is new and that is prepared in a unique way.

The basic concept is to form a dessert that resembles a gyro and uses some similar ingredients and some new ingredients. Such a dessert can be prepared by using the assembly process and recipe provided below. Generally, the dessert is a chocolate pita-based dessert. Any desirable type of chocolate can be used, including dark chocolate, milk chocolate, white chocolate, a flavored chocolate, or some combination of these chocolates.

Generally, it is desirable that the chocolate be soft enough to make slicing and handling the chocolate easier, whereas a harder chocolate would be more difficult to slice and handle. Hence, a chocolate having ingredients to help keep the chocolate softer would be useful, such as a chocolate that substitutes some portion of the cocoa butter with a dairy or vegetable oil might be used.

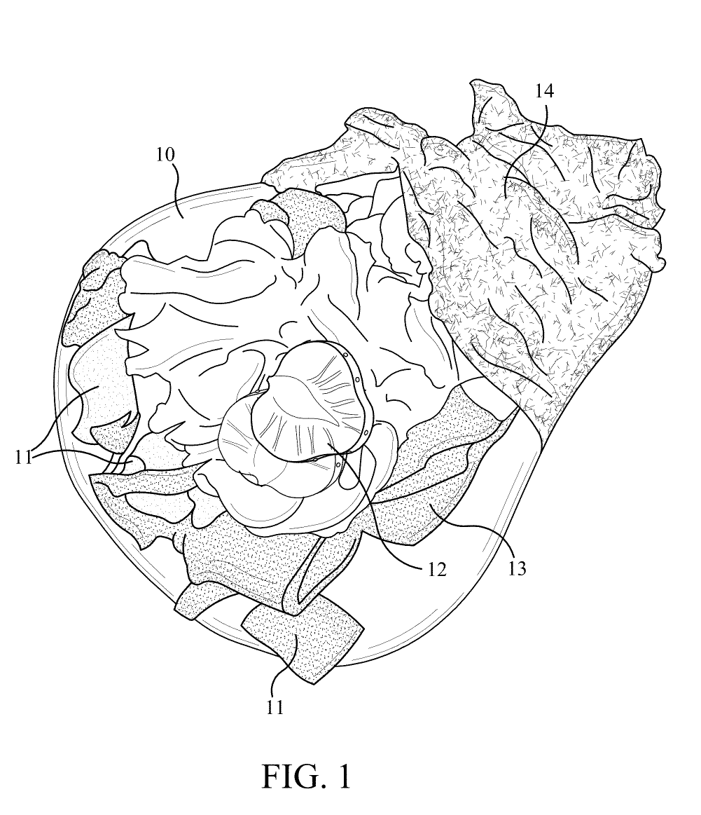

The chocolate gyro can be generally prepared by using shavings or pieces of chocolate placed on a flat pita similar to how gyro meat is placed on a pita for a gyro sandwich. If desired, the pita may be prepared in advance with a layer of a spread such as Nutella® to provide additional sweetness and flavor. The pita may be a traditional gyro pita of any desired size or style, or the chosen pita may be a sweetened version of a pita specifically provided for desserts. Fruits, nuts, whipped cream, and/or any other filling may be added to the flat pita, and then the pita is partially or fully folded in the manner of a meat gyro and then completely or partially wrapped in a protective wrapping (such as by using cut sheets of foil, paper, wax paper, parchment, or plastic, for example), for serving to a user. FIG. 1 shows an example dessert gyro that has been partially folded and only partially wrapped, including a pita 10, chocolate shavings 11, fruit (in this case sliced strawberries 13) and whipped cream 12 with a partial foil wrap 14.

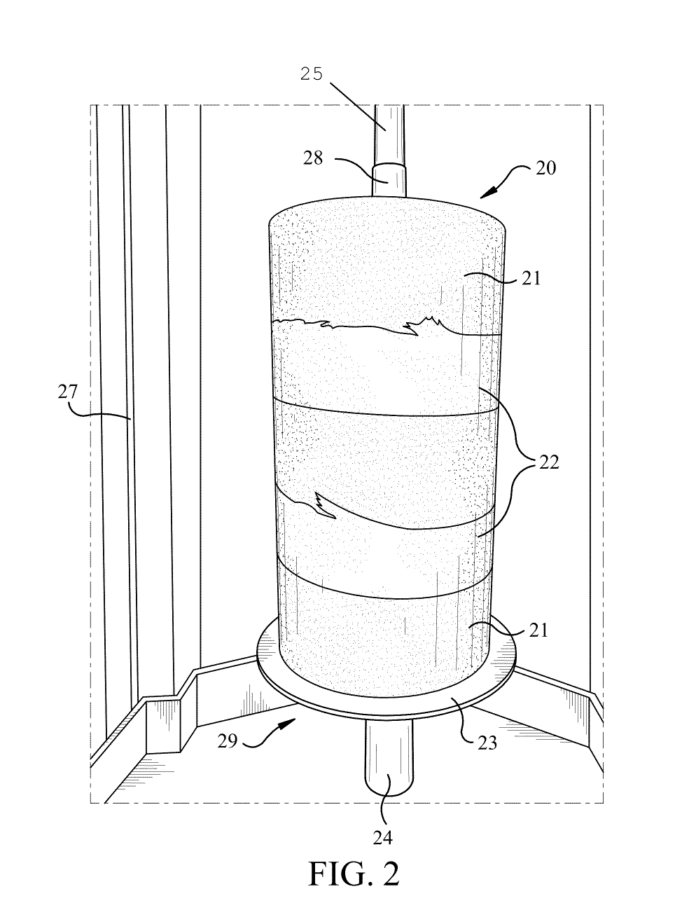

In particular, it is sometimes desired to invoke much of the gyro preparation process for use in preparing the chocolate gyro, and hence a large piece of chocolate that has been molded or otherwise formed into the shape of a gyro “cone” can be utilized. Such a chocolate cone is indicative of the gyro meat cone that is typically used to prepare gyros. FIG. 2 shows an example of such a chocolate “cone” 20 that is provided on a spit 29 a having a structure including a base 23 on which the chocolate cone will rest, an axel 24 extending from the base 23, and a spindle 25 traveling down the axis of the chocolate cone 20 for stabilizing the cone with grommet 28 on the spindle 25 to help hold the cone in place. The example chocolate cone of the figure has both milk chocolate layers 21, and white chocolate layers 22.

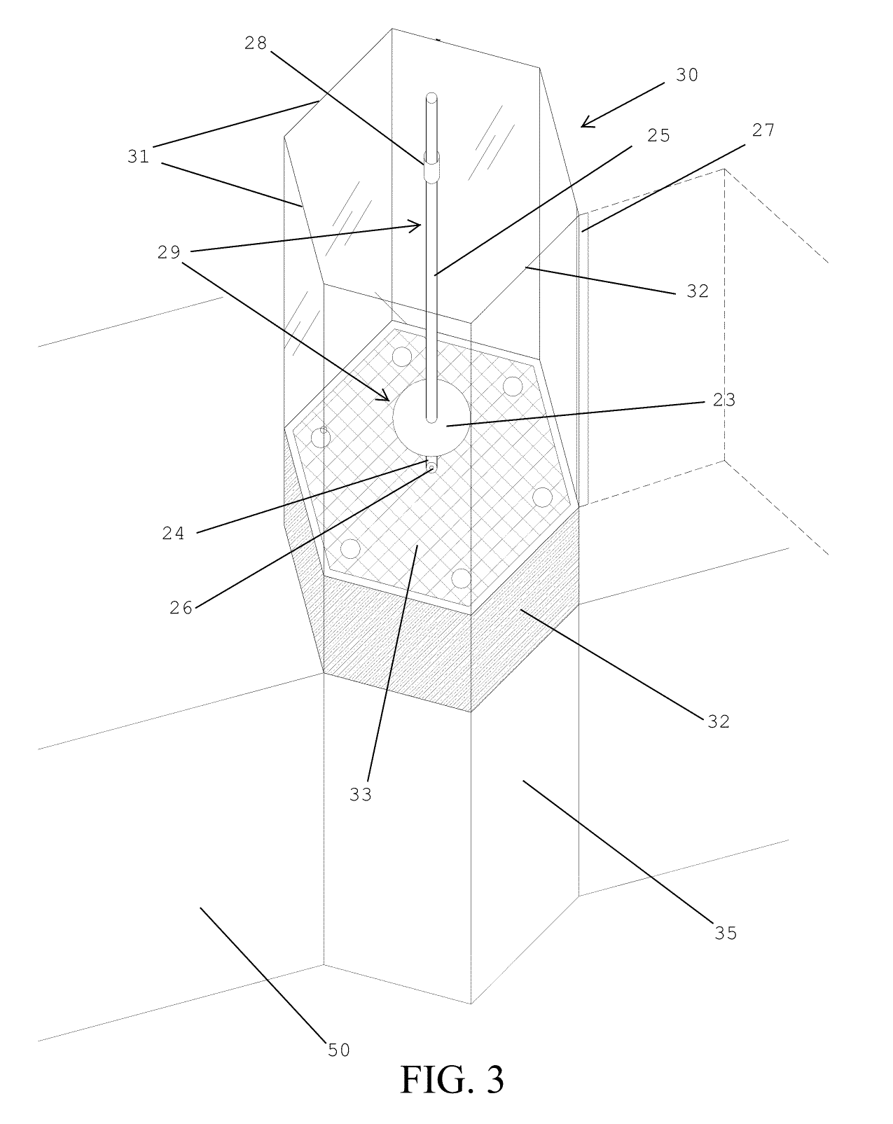

The chocolate cone 20 mounted on a spoke 25 of the spit 29 (shown in FIG. 2) can be placed inside a specially designed display unit, such as the example unit 30 shown in FIG. 3 sitting on a counter 35 and housing the spit 29. This display unit 30 is adapted to mechanically receive the spit 29 that holds the chocolate cone (not shown) as described above, where the axel 24 is received by the base 32 of the display unit by a corresponding receptacle 26. A motor (not shown) may be provided within the base for connecting to the axel 24 for rotating the chocolate cone, if desired, or the cone may be manually rotated, to provide access to various portions of the chocolate cone. The base 32 may have a tray 33 with a vent for providing cooling (or in some cases heating) air flow. Alternatively, vents may be provided on sides of the cone or in one or more the walls 31, rather than, or in addition to, the vents in the base 33. Another alternative is to provide a coolant flowing through the base 32, the tray 33 and/or one or more of the walls 31. As a further alternative, the chocolate cone may be cooled more directly, such as by providing a cooling fluid through portions of the spit, such as the spoke 25, the base 23, or both. Note that the “coolant” can provide either cooling functions, heating functions, depending on the desired application of the display unit. Such a coolant might be water, or a refrigerant, for example.

Generally, the display unit 30 will have one or more transparent walls 31 to allow viewing of the chocolate cone by the public during preparation and sale of the dessert, and at least one wall 32 will either be adapted to be an access door (which may be transparent to improve viewing), or will be completely or partially omitted to provide the desired access.

The display unit 30 of an example embodiment will be configured to ensure that the environment within the display unit is maintained at a proper temperature for ease of carving the chocolate cone for use in preparing the pita. Pieces of the chocolate can be shaved off the chocolate cone, such as by using a knife, or a wire cutter like a cheese cutter. The resulting chocolate shavings are placed into a warm pita that has been prepared as desired, such as with a desired spread (e.g., Nutella®).

Additional ingredients may be added for additional flavor and/or texture, such as crushed cookies (e.g., vanilla wafers, Oreos®, etc.), nuts (such as pecans, almonds, walnuts, cashews, peanuts, hazelnuts, etc.), fruit pieces (such as bananas, strawberries, raspberries, peaches, apples, etc.) and/or toppings (such as whipped cream, custard, Cool Whip®, etc.), thereby creating the chocolate gyro. Alternative ingredients can be substituted for the above, such as regional fruits or other regional dessert items.

One alternative for providing the display unit can utilize a modified commercial gyro machine to refrigerate the chocolate cone in contrast to heating the traditional gyro meat cone, but that solution has not proven optimal for many situations, as such machines, since they are typically used to heat traditional gyro meat rather than keep it cool, is not optimized for cooling functionality. Hence, an air conditioning system can be provided that will cool or heat the display unit as needed based on the expected sales environment to keep the chocolate at a proper desired temperature.

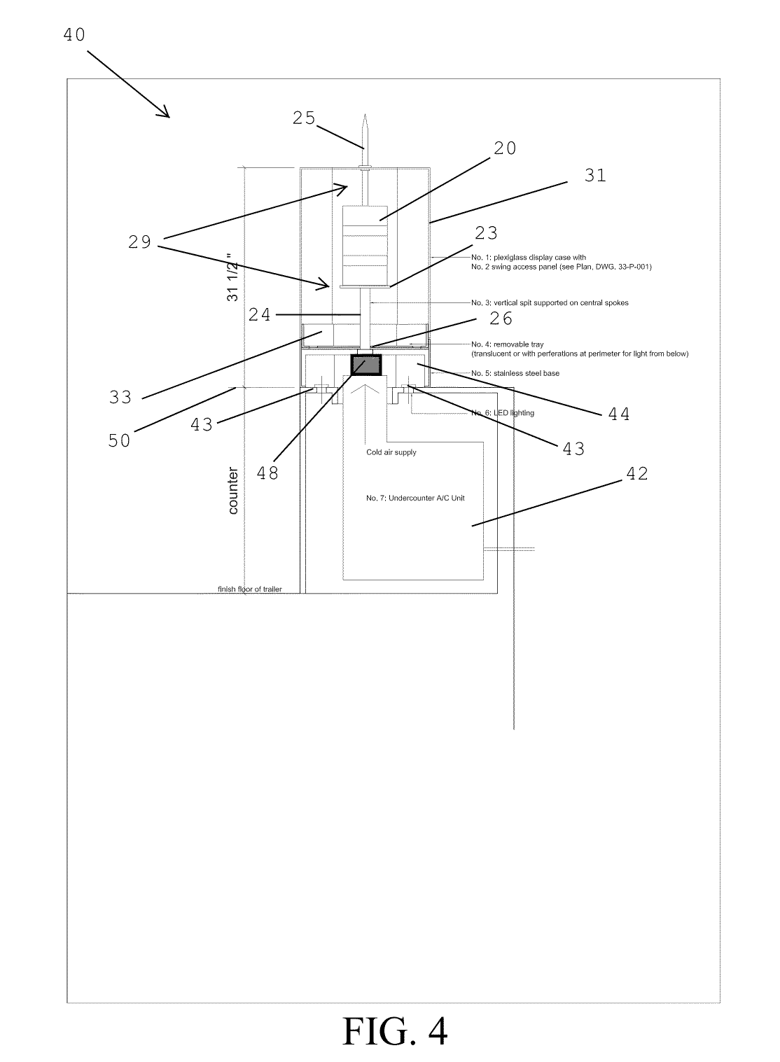

Hence, a completely new display unit can be configured to provide the desired cooling function (for most uses) or heating function, to keep the chocolate at the desired temperature. One such example, as shown by the display unit 40 of FIG. 4, is adapted for holding the chocolate cone 20 provided on the spit 29, as shown in the figure. This new machine is comprised of a stainless steel base 44 covering an air conditioning system 42 (e.g., a refrigeration and/or heating system) that provides a temperature regulated air flow for keeping the chocolate gyro cone at the proper temperature (e.g., cooled in most situations, warmed in some). At least part of the air conditioning system 42 may be provided under a counter 50. Secured to the base 44 through the receptacle 25 is the spit 29 which may be comprised of steel or stainless steel or aluminum or a hard plastic or glass, or another material of desired strength and durability. The sides and top of the machine are enclosed by walls 31 comprised of transparent panels, such as panels made, for example, from plexi-glass or glass, which can be lit from underneath using LED lights 43. Optional motor 48 can be used to rotate the spit 29 and hence the cone 20.

The display unit 40 ensures that the chocolate cone remains at the proper temperature for ease of carving and serving, and allows the buying public to see the chocolate cone on display to encourage purchase of the dessert. One (or more) of the transparent panels is arranged into a folding or swinging door, allowing access to the chocolate cone by the person preparing the pita.

This new display unit serves three main purposes, among others. The first is displaying the chocolate cone vertically for the public to see (as the traditional gyro machine displays the gyro meat), the second is keeping the chocolate at a constant temperature, typically of about 65-70 degrees Fahrenheit (within a couple of degrees, for example, or any other cooled temperature chosen to preserve the chocolate in a cool, and hence solid, state), and the third is keeping the chocolate cone in the vertical position in order to allow for ease of shaving of the chocolate to prepare the dessert.

Note that in some circumstances, such as in cold climates or overly cooled rooms, rather than being cooled, the chocolate cone may need to be slightly heated to keep it at the proper serving temperatures (e.g. about 65-70 degrees Fahrenheit). In such circumstances, the cooling machine may be provided with a heater (e.g., an electric heater) as well as a refrigeration system to maintain the proper temperature, or in some circumstances a heater may replace the refrigeration system. A combination of heating and cooling functions may be utilized to better control the interior temperature of the display unit for more general application.

For an example embodiment, plexi-glass panels can be used to allow for optimum viewing of the chocolate in the display unit from all angles, and the folding plexi-glass door can be used to provide access into the display unit to the chocolate cone in order to shave the chocolate. Glass, or another transparent plastic material might be used as an alternative to plexi-glass The chocolate cone is formed, for example, onto a narrow, hollow center piece (which may be a plastic or paper tube, for example, or just a hollow space within the chocolate), which allows the chocolate cone to be slid onto the spoke of vertical spit. The stainless steel base of the cooling machine can be used to hide a control system for the machine, e. g., the cooling/heating system ducts and cables, as well as the display lights. For an example embodiment, LED lights allow the machine and chocolate to be lit at night. The refrigeration/heating system, which can be located underneath the serving counter, keeps the chocolate at the desired temperature.

In addition to providing one of the disclosed machines for use in preparing the chocolate pita dessert, also developed is the chocolate gyro cone for use with the machine. This example chocolate cone is molded in the shape of the traditional meat gyro cone, with the chocolate cone weighing about 10 kg and being comprised, for example, of alternating bands of white and milk chocolate. Many different recipes for the chocolate cone can be utilized, based on the desired deserts, including the use of white, dark, milk, or other flavored chocolates, as desired.

To prepare an example of an individual chocolate pita dessert using the disclosed equipment, a pita is warmed on a griddle and placed onto a folded piece of wrap, such as aluminum foil. Nutella® is then spread onto the warm pita, followed by crushed vanilla wafers, and freshly cut strawberries and bananas. Chocolate is shaved from the chocolate cone using a knife or other cutting instrument, and the freshly shaved chocolate is placed on the warmed pita and then topped with whipped cream. The finished pita is then wrapped as per an original meat gyro and is ready for sale (as shown in FIG. 1). Because the pita is warmed in advance, the chocolate will at least partially melt, creating a mouth-watering, delicious dessert.

A traditional pita may be used for the dessert, or a special dessert pita following a unique dessert pita recipe could be used. The advantage of using a new pita recipe is that a sweeter pita could be used that may be thinner, thicker or the same thickness of the typical bread pita.

The resulting chocolate pita can be sold from food trailers at fairs and carnivals, and food stands and food trucks. In addition to these venues, the ‘CHYRO™’ can be sold at restaurants, catering halls and any other location where such a dessert might be enjoyed.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of preparing a dessert, comprising the steps of:
providing a chocolate cone in an at least partially transparent display unit at a sales location;
maintaining a desired temperature of the chocolate cone using an air conditioning system operating in conjunction with said display unit;
providing a pita;
carving the chocolate cone to obtain chocolate shavings;
placing the chocolate shavings on the pita;
wrapping the pita with the chocolate shavings to configure the pita for sale; and
selling the pita to a customer at the sales location.

2. The method of claim 1, wherein the air conditioning system is configured to cool the interior of the display unit to cool the chocolate cone.

3. The method of claim 2, wherein the air conditioning system is also configured to heat the interior of the display to heat the chocolate cone.

4. The method of claim 1, further comprising providing a fruit and whipped topping on the pita prior to wrapping the pita.

5. The method of claim 4, wherein the pita is heated prior to placing the chocolate shavings on the pita.

6. The method of claim 1, wherein the pita is heated prior to placing the chocolate shavings on the pita.

7. The method of claim 1, wherein the air conditioning system maintains the chocolate cone at a desired temperature of between about 65 and 70 degrees F.

8. The method of claim 1, wherein said chocolate cone is comprised of white chocolate and milk chocolate portions.

9. The method of claim 1, wherein said air conditioning system is adapted to cool the interior of the display unit.

10. A method of preparing and selling a dessert, comprising the steps of:
providing a chocolate cone on a spit in an a display unit at a sales location, wherein said display unit comprises a door for providing access to an interior of the display unit;
maintaining a desired temperature of the chocolate cone using an air conditioning system operating in conjunction with said display unit configured to heat or cool an interior of said display unit;
heating a pita;
carving the chocolate cone to obtain chocolate shavings;
placing the chocolate shavings on the heated pita resulting in said chocolate shavings at least partially melting;
adding additional dessert toppings to the heated pita;
wrapping the pita provided with the chocolate shavings and toppings to configure the pita for sale; and
selling the pita to a customer at the sales location.

11. The method of claim 10, further comprising providing a fruit and whipped topping on the pita prior to wrapping the pita.

12. The method of claim 10, wherein the air conditioning system maintains the chocolate cone at a desired temperature of between about 65 and 70 degrees F.

13. The method of claim 10, wherein said chocolate cone is comprised of white chocolate and milk chocolate portions.

14. The method of claim 10, wherein display unit comprises at least one transparent wall.

15. A display unit configured for use in preparing a dessert, comprising:
a base;
a spit configured to hold a chocolate cone in a vertical position installed on said base, said spit being configured to be installed within said display unit;
at least one transparent wall installed on said base and configured to allow viewing of the chocolate cone on said spit when installed within said device;
an opening configured to provide access to a worker for carving shavings from the chocolate cone provided on the spit; and
an air conditioning system configured to maintain the chocolate cone at a desired temperature, wherein
said device is adapted of a size to be placed on a counter or table for use in a sales location directly observable by a consumer.

16. The display unit of claim 15, wherein said air conditioning system is configured to cool an interior of the display unit.

17. The display unit of claim 15, wherein said air conditioning system is configured to cool directly cool the chocolate cone.

18. The display unit of claim 15, wherein said spit is further configured to rotate the chocolate cone within said display unit.

19. The display unit of claim 15, further comprising a door adapted for use with said opening.

20. The display unit of claim 19, wherein said door is at least partially transparent.

21. The method of claim 15, wherein the air conditioning system maintains the chocolate cone at a desired temperature of between about 65 and 70 degrees F.
